(19) United States
(12) Patent Application Publication
(10) Pub. No.: US 2009/0246578 A1
(43) Pub. Date: Oct. 1, 2009

(54) THERMAL MANAGEMENT IN A FUEL CELL SYSTEM

(75) Inventors: Craig Evans, Portland, OR (US); Evan Rege, Portland, OR (US); Ru Chen, Portland, OR (US); Zakiul Kabir, Hillsboro, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: ClearEdge Power, Inc., Hillsboro, OR (US)

(21) Appl. No.: 12/060,760

(22) Filed: Apr. 1, 2008

(51) Int. Cl. H01M 8/00

(52) U.S. Cl. 429/20; 429/19

(57) ABSTRACT

Embodiments of thermally integrated HT PEM fuel cell systems are disclosed. In one disclosed embodiment, a fuel cell system comprises a fuel cell, a fuel processor configured to form a processed fuel for the fuel cell, and a thermal management system comprising a heat transfer fluid circulation loop that circulates a heat transfer fluid through the fuel cell and through the fuel processing system in a common loop.

### BACKGROUND

A high temperature proton exchange membrane (HT PEM) fuel cell system may utilize a raw fuel in the form of a hydrocarbon that is processed to form a hydrogen-rich gas to feed the fuel cell. Extraction of hydrogen from a hydrocarbon fuel may be performed in a fuel processor comprising reactors such as a reform reactor and a water gas shift (WGS) reactor. The use of such a fuel processor allows PEM fuel cell systems to use fuels that are more readily available than hydrogen.

Various types of reformers are known, but the most commonly used reformers for PEM fuel cell systems are catalytic steam reformers (CSR) and auto thermal reformers (ATR). Both of these types of reformers are generally operated at high temperatures (800° C. to 1000° C.), and utilize water vapor as a reactant to produce hydrogen from a hydrocarbon fuel. Waste carbon monoxide from the reforming process may then be fed to one or more WGS reactors in series to react with water vapor, thereby generating more hydrogen for use by the fuel cell.

A HT PEM fuel cell generally operates at a temperature of approximately 160-180 degrees Celsius, while a WGS reactor operates optimally at temperatures between approximately 200-300 degrees Celsius. The chemical reactions in a PEM fuel cell and a WGS reactor are exothermic. Therefore, these devices may utilize cooling systems for temperature control during use. On the other hand, reform reaction is an endothermic reaction, and reformers therefore require input of heat to perform the reform reaction. In light of the different thermal characteristics of these devices, thermal management in a fuel cell system that utilizes more than one of these devices may pose challenges.

### SUMMARY

Accordingly, various embodiments of thermally integrated HT PEM fuel cell systems are disclosed herein. For example, in one disclosed embodiment, a fuel cell system comprises a fuel cell, a fuel processor configured to form a processed fuel for the fuel cell, and a thermal management system comprising a heat transfer fluid circulation loop that circulates a heat transfer fluid through the fuel cell and through the fuel processing system in a common loop. The use of a common loop thermal management system to thermally interact with both a fuel cell and a fuel processor for the fuel cell may simplify and reduce the costs of a fuel cell power generation system compared to the use of separate thermal management systems for each device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of an embodiment of a fuel cell system.

FIG. 2 shows a flow diagram of an embodiment of a method of operating a fuel cell system.

### DETAILED DESCRIPTION

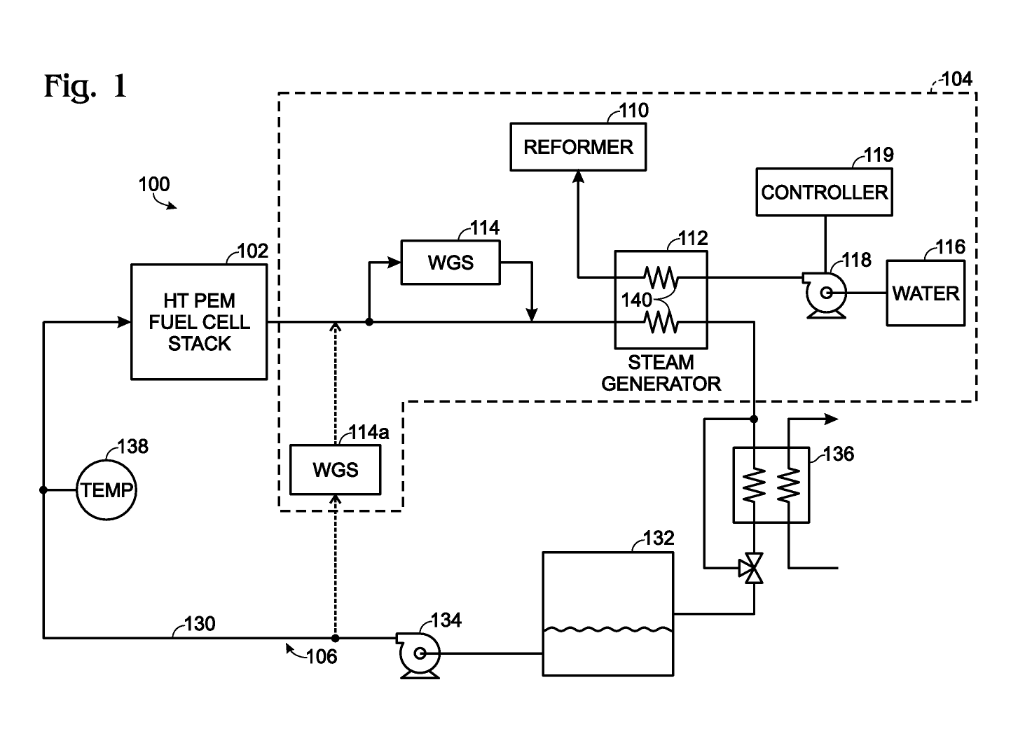

FIG. 1 shows an embodiment of a fuel cell power generation system 100. Fuel cell power generation system 100 (herein after referred to as “fuel cell system 100”) comprises a HT PEM fuel cell stack 102 comprising one or more fuel cells, a fuel processing system 104, and a thermal management system 106. The connections between the individual components shown in FIG. 1 schematically illustrate the connectivity of the components from a thermal management perspective. Therefore, various other connectivities between the components, including but not limited to some electrical and logical connections, are omitted from FIG. 1 for clarity.

The fuel processing system 104 as depicted comprises a reformer 110, a steam generator 112 to generate steam for the reformer 110, and a WGS reactor system 114 comprising one or more WGS reactors. An alternative location for the WGS reactor system is shown at 114a. The reformer 110 is configured to form hydrogen gas from a raw hydrocarbon, and the WGS reactor system 114 is configured to convert carbon monoxide and water vapor in effluent from the reformer 110 into hydrogen and carbon dioxide, thereby improving the quality of the reformer effluent for use in the fuel cell stack 102. In one embodiment, the WGS reactor system 114 comprises an adiabatic WGS reactor and an isothermal or actively cooled WGS reactor. However, other WGS reactor system configurations may be used in other embodiments, and may comprise as few as one, or three or more, WGS reactors or sections in one or multiple vessels.

The fuel processing system 104 also comprises a water supply 116 and a water flow control 118 to allow for addition of water to the steam generator. The water flow control 118 may be controlled by an electronic controller 119 to add water to the steam generator 112 on an as-needed basis. The water flow control 118 may include any suitable component or components. Examples include, but are not limited to, a metering pump (as depicted), one or more valves, etc. It will be appreciated that a fuel processing system may include any suitable sub-group of these components, and/or any additional components other than those depicted, without departing from the scope of the disclosure.

The thermal management system 106 is configured to control the temperature of the fuel cell stack 102, and also to transfer heat to or from one or more components of the fuel processing system 104. The thermal management system 106 comprises a heat transfer loop 130, a heat transfer fluid tank 132, and a heat transfer fluid circulation pump 134 configured to circulate heat transfer fluid through the fuel cell system 100.

A temperature of the heat transfer fluid may be controlled via a thermal control system 136. The thermal control system 136 may be configured to add heat to and/or remove heat from the heat transfer fluid. For example, heat may be added to the heat transfer fluid by the thermal control system 136 to heat up the fuel cell stack 102 during system start-up. Likewise, heat may be removed from the heat transfer fluid by the thermal control system 136 to help cool the fuel cell stack 102 once the fuel cell stack 102 is up and running. A temperature sensor 138 may be used to provide feedback to the thermal control system 136 to help regulate the temperature of the fuel cell stack 102, as well as other components of the fuel cell system 100. Any suitable fluid may be used as a heat transfer fluid. Suitable fluids include, but are not limited to, synthetic oils such as Multitherm OG-1, available from Multitherm LLC of Malvern, Pa.

As mentioned above, the chemical reactions that occur in the fuel cell stack 102 and the WGS reactor system 114 are exothermic, and produce waste heat. Further, each of these components has a temperature range for proper operation. Hot or cool spots in the components may harm component performance. Therefore, thermal regulation of each of these components may help to ensure that the temperature of each component stays within a suitable temperature range.

However, the use of separate thermal management systems for these components may be expensive due to duplicative control systems, pumps, heat exchangers, etc. Therefore, in the embodiment of FIG. 1, the temperatures of both the fuel cell stack 102 and the WGS reactor system 114 are controlled by a common heat transfer loop fluid circulation loop 130. The use of a common heat transfer loop 130 to control the temperature of each of these components may reduce costs and simplify system design relative to the use of separate thermal control systems for each of these components. The term “common heat transfer loop” as used herein represents the use of a common thermal control system, pump 134, etc. to control the heat of two or more components. It will be understood that a common loop as defined herein may include one or more branches that form sub-loops, such as the sub-loop indicated where the WGS reactor system is located in position 114a.

The WGS reactor system 114 may have any suitable location along the thermal management system 106 relative to the fuel cell stack 102. The relative locations of these components along the thermal management system 106 may depend upon various factors, including but not limited to the desired inlet temperature of the heat transfer fluid at the WGS reactor system 114. For example, HT PEM fuel cell stacks generally operate in a range of approximately 160-180 degrees Celsius. For such a fuel cell stack, an example of suitable range of temperatures for a heat transfer fluid at the inlet of the fuel cell 102 is between approximately 140-160 degrees Celsius. Under such conditions, the temperature of the heat transfer fluid at the outlet of the fuel cell stack 102 may be in the range, for example, of 150-175 degrees Celsius. Therefore, placement of the WGS reactor system 114 parallel to the fuel cell stack 102 will deliver the heat transfer fluid to the WGS reactor system 114 inlet at approximate the same temperature as to the fuel cell stack 102 inlet, whereas placement downstream of the fuel cell stack will cause the delivery of relatively warmer heat transfer fluid to the WGS reactor system 114. In either case, because the WGS reactor system 114 generally has a desired operating temperature range of approximately 200-300 degrees Celsius, the heat transfer fluid at the inlet of the WGS reactor system in either of these locations is cooler than the WGS reactor system 114 temperature during operation. Therefore, the heat transfer fluid may be used to effectively cool the WGS reactor system 114 in either position.

In the depicted embodiment, the heat transfer loop 130 also passes through the steam generator 112 at a location along the loop downstream of the fuel cell stack 102 and the WGS reactor system 114. In this manner, waste heat from the fuel cell stack 102 and the WGS reactor system 114 may be transferred to water within the steam generator 112 via a heat transfer element, indicated schematically at 140, for the generation of steam for reformer 110. This allows waste heat from the fuel cell stack 102 and/or the WGS reactor system 114 to be used to convert liquid water to the vapor phase, and thereby may help to improve the overall system efficiency. In the depicted embodiment, waste heat from both the fuel cell stack 102 and the WGS reactor system 114 is delivered to the steam generator. However, in other embodiments, heat from only one of these devices may be delivered to the steam generator.

The use of waste heat from the fuel cell stack 102 and/or the WGS reactor system 114 to create steam in the steam generator 112 for the reformer 110 may offer other advantages besides the efficient use of waste heat. For example, this may allow steam to be created on-demand, rather than created ahead of time and then metered to the reformer. In the depicted embodiment, liquid water from the water supply 116 may be added to the steam generator 112 via water flow control 118 when it is determined by controller 119 to add water vapor to the reformer 110.

Controlling the quantity of water added to the reformer 110 via the metering of liquid water to the steam generator 112 may provide advantages over the metering of steam to the reformer 110. For example, the creation and storage of steam prior to demand for the steam may be more energy-intensive than the creation of steam in an on-demand manner, and may require more complex and/or expensive equipment. Further, the metering of steam to the reformer 110 may require complex control systems to control the pressure and temperature of steam that is stored for addition to the reformer. Additionally, a mass of steam added to the reactor may be more difficult to control via the metering of steam than via the metering of liquid water. In contrast, the metering of liquid water into the steam generator 112 as needed may allow accurate, controllable quantities of water to be added to the reformer in a simple, easy-to-control manner.

The steam generator 112 may comprise any suitable heat exchange system for transferring heat from the heat transfer loop 130 to water in the steam generator. Examples include, but are not limited to tube-in-tube heat exchangers, shell-and-tube heat exchangers, plate heat exchangers and/or coil-type heat exchangers.

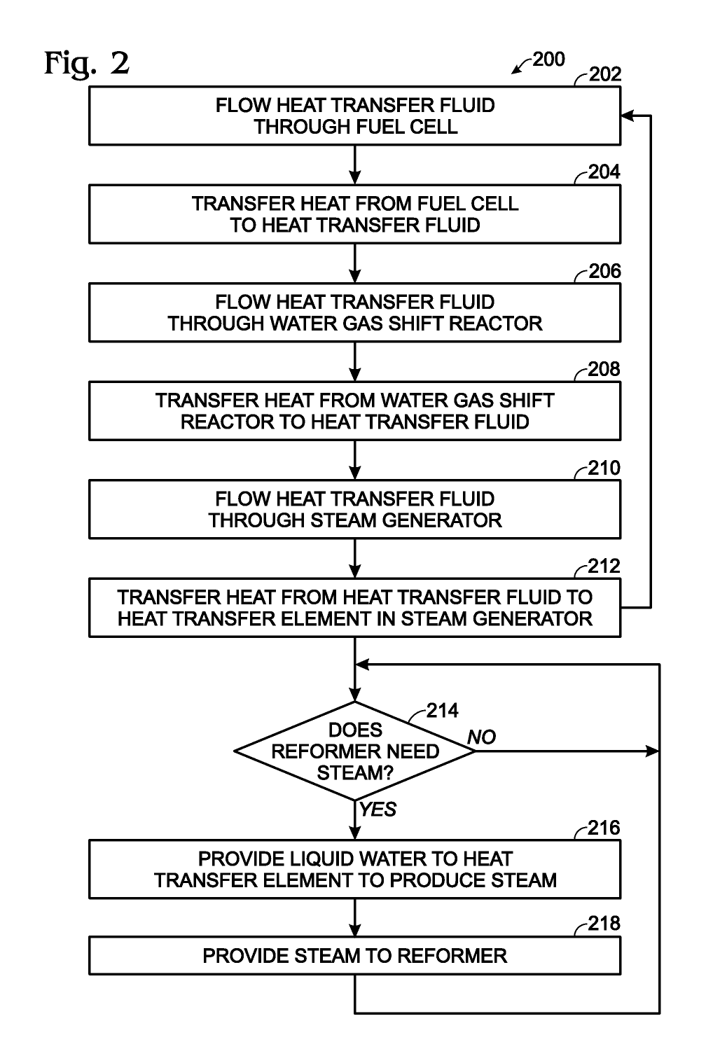

FIG. 2 shows a flow diagram depicting a method of operating a fuel cell. Method 200 first comprises, at 202, flowing a heat transfer fluid through a fuel cell heat exchange system, and then at 204, transferring heat from the fuel cell to the heat transfer fluid to thereby cool the fuel cell. Method 200 also comprises, at 206, flowing the heat transfer fluid through a WGS reactor heat exchange system, and then at 208, transferring heat from the WGS reactor to the heat transfer fluid. The WGS reactor and fuel cell may be arranged along a heat exchange fluid circulation loop in series or in parallel. Therefore, the processes shown at 202-204 and at 206-208 may be performed in parallel or in series. In either arrangement, the cooling of both devices via a single cooling loop may simplify the thermal management system and reduce costs compared to the use of separate cooling systems for each of these devices.

Next, method 200 comprises, at 210, flowing the heat transfer fluid through a steam generator, and then at 212, transferring heat from the heat transfer fluid to a heat exchange element in the steam generator. In this manner, the heat exchange element in the steam generator has heat available for the vaporization of liquid water when steam is demanded by a steam reformer. The process of transferring heat from the fuel cell and/or the WGS reactor continues during fuel cell operation, as indicated by the arrow connecting processes 212 and 202, thereby continuing to provide heat to the steam generator. While the depicted embodiment shows the transfer of heat from both the WGS reactor and the fuel cell to the steam generator, in other embodiments, heat transfer from either the WGS reactor or the fuel cell to the steam generator may be omitted such that heat from only one of these devices is provided to the steam generator.

Continuing with FIG. 2, method 200 next comprises, at 214, determining whether the reformer needs steam. This decision may be based, for example, on a quantity or flow of hydrocarbon being added to the reformer, and/or on other suitable factors. When steam is needed, method 200 comprises, at 216, providing liquid water to the heat transfer element in the steam generator to produce steam for the reformer, and then at 218, providing the steam to the reformer. In this manner, waste heat from the WGS reactor and/or the fuel cell is utilized to create steam for the reformer, thereby contributing to the efficient utilization of waste heat from the fuel cell and WGS reactions and also avoiding for the use of a steam generator such as a steam boiler or a steam drum.

The embodiments described herein may be used with any suitable raw hydrocarbon fuel. Suitable raw fuels may include, but are not limited to, biodiesel, vegetable oils, etc. Further, it will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof

1. A fuel cell system, comprising:
a fuel cell;
a fuel processor configured to form a processed fuel for the fuel cell; and
a thermal management system comprising a heat transfer fluid circulation loop configured to circulate a heat transfer fluid through the fuel cell and through the fuel processing system in a common loop.

2. The fuel cell system of claim 1, wherein the fuel processor comprises a water gas shift reactor through which the heat transfer fluid flows.

3. The fuel cell system of claim 2, wherein the water gas shift reactor is disposed along the heat transfer fluid circulation loop in a location downstream of the fuel cell.

4. The fuel cell system of claim 2, wherein the water gas shift reactor is disposed along the heat transfer fluid circulation loop in a location parallel to the fuel cell.

5. The fuel cell system of claim 1, wherein the fuel processor comprises a steam generator disposed along the heat transfer fluid circulation loop downstream of the fuel cell, and wherein the steam generator comprises a heat transfer element configured to transfer heat from the heat transfer fluid to liquid water in the steam generator.

6. The fuel cell system of claim 5, wherein the fuel processing system further comprises a water supply coupled to the steam generator to supply liquid water to the steam generator, and a water flow control disposed between the water supply and the steam generator.

7. The fuel cell system of claim 6, further comprising a controller in electrical communication with the water flow control, wherein the controller is configured to control via the water flow control an amount of liquid water supplied to the steam generator based upon an amount of steam to be supplied to a reforming reactor.

8. The fuel cell system of claim 1, wherein the fuel processing system comprises a water gas shift reactor disposed along the heat transfer fluid circulation loop at a location downstream of the fuel cell, and a steam generator disposed along the heat transfer fluid circulation loop at a location downstream of the fuel cell and the water gas shift reactor.

9. The fuel cell system of claim 8, wherein the fuel processing system further comprises a water supply coupled to the steam generator and a water flow control disposed between the water supply and the steam generator.

10. A fuel cell system, comprising:
a fuel cell;
a steam reformer coupled to the fuel cell to provide a reformed fuel to the fuel cell;
a steam generator coupled to the reformer to generate steam for the steam reformer; and
a thermal management system comprising a heat transfer fluid circulation loop configured to provide a flow of a heat transfer fluid to the fuel cell and then from the fuel cell to a heat transfer element within the steam generator.

11. The fuel cell system of claim 10, further comprising a water supply coupled to the steam generator, and a water flow control disposed between the water supply and the steam generator.

12. The fuel cell system of claim 11, further comprising a controller in electrical communication with the water flow control, wherein the controller is configured to control via the water flow control an amount of liquid water supplied to the steam generator based upon an amount of steam to be supplied to a reforming reactor by the steam generator.

13. The fuel cell system of claim 10, further comprising a water gas shift reactor through which the heat transfer fluid flows.

14. The fuel cell system of claim 13, wherein the water gas shift reactor is disposed along the heat transfer fluid circulation loop in a location downstream of the fuel cell.

15. The fuel cell system of claim 13, wherein the water gas shift reactor is disposed along the heat transfer fluid circulation loop in a parallel relation with the fuel cell.

16. A fuel cell system, comprising:
a fuel cell;
a water gas shift reactor coupled to the fuel cell to produce hydrogen for the fuel cell; and
a thermal management system comprising a heat transfer fluid circulation loop that circulates a heat transfer fluid through the water gas shift reactor and the fuel cell in a common loop.

17. The fuel cell system of claim 16, wherein the water gas shift reactor is arranged in parallel to the fuel cell along the heat transfer fluid circulation loop.

18. The fuel cell system of claim 16, wherein the water gas shift reactor is arranged downstream of the fuel cell along the heat transfer fluid circulation loop.

19. The fuel cell system of claim 16, further comprising a steam generator disposed along the heat transfer fluid circulation loop downstream of the fuel cell, and wherein the steam generator comprises a heat transfer element configured to transfer heat from the heat transfer fluid to water in the steam generator.

20. The fuel cell system of claim 19, wherein the fuel processing system comprises a water supply coupled to the steam generator and a water flow control disposed between the water supply and the steam generator.
